(19) United States
(12) Patent Application Publication
(10) Pub. No.: US 2026/0170323 A1
(43) Pub. Date: Jun. 18, 2026

(54) VISUAL TOKENIZATION WITH LANGUAGE MODELS

(71) Applicant: Google LLC, Mountain View, CA (US)

(72) Inventors: Lijun Yu, Pittsburgh, PA (US); José Lezama Torres de la Llosa, Atlanta, GA (US); Irfan Aziz Essa, Atlanta, GA (US); Lu Jiang, Mountain View, CA (US); David A. Ross, San Jose, CA (US)

(21) Appl. No.: 19/125,046

(22) PCT Filed: Sep. 30, 2024
(86) PCT No.: PCT/US2024/049296

§ 371 Date: Apr. 28, 2025

Related U.S. Application Data
(60) Provisional application No. 63/541,289, filed on Sep. 28, 2023.

(51) Int. Cl. G06N 3/08

(52) U.S. Cl. CPC G06N 3/08

(57) ABSTRACT

Methods, systems, and apparatus, including computer programs encoded on a computer storage medium, for quantizing a visual input to generate a visual output. In one aspect, a method comprises receiving a visual input, processing the visual input using an encoder neural network to generate multiple feature vectors, generating a quantized representation that identifies a respective visual token from a vocabulary of visual tokens for each feature vector by mapping each dimension of the feature vector to a corresponding integer value from a set of integer values, and generating data identifying the visual token based on the integer values. In another aspect, the system receives and processes a conditioning input using a visual token generation neural network to generate a sequence of visual tokens each including an integer value for each of multiple dimensions, and processing the sequence of visual tokens using a decoder neural network to generate a visual output.

### CROSS-REFERENCE TO RELATED APPLICATION

This application claims priority to U.S. Provisional Application No. 63/541,289, filed on Sep. 28, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that performs visual token generation by processing a visual input using a neural network.

In some examples, the system can perform compression of a visual input. In particular, the system can receive a visual input, and the system can process the visual input using an encoder neural network to generate multiple feature vectors that represent the visual input.

As used in this specification, a visual input is an image or a video including multiple images.

A feature vector is a vector of one or more dimensions. For example, each feature vector can correspond to a respective image patch of a respective image of the visual input or can correspond to a spatio-temporal patch of a video that includes pixel values from co-located patches within multiple different adjacent video frames from the video.

In this example, the system can generate a quantized representation of the visual input.

As used in this specification, the quantized representation identifies, for each feature vector, a visual token from a vocabulary of visual tokens. The visual token is a vector that includes a respective integer value for each of the one or more dimensions of the corresponding feature vector Each visual token corresponds to a token identifier. The multiple token identifiers represent a compressed version of the visual input.

In some examples, the token identifiers can be provided to a decompression system to perform decompression in order to reconstruct the visual input.

For example, the token identifiers may be stored (e.g., in a physical data storage device or logical data storage area), and then subsequently retrieved from storage and provided to the system to perform decompression.

As another example, the token identifiers may be transmitted over a communications network (e.g., the Internet) to a destination, where they are subsequently retrieved and provided to the system to perform decompression.

As another example, the system can encode the token identifiers as a bitstream (e.g., through entropy encoding), where each of the token identifiers are mapped to a bit value. In this case, the system can store or transmit the bitstream over a communications network and then subsequently retrieve the bitstream to perform decompression.

The system can map the token identifiers to visual tokens in order to generate a reconstruction of the visual input using a decoder neural network.

Instead of or in addition to using the visual tokens for compression and decompression, in some examples, the system can receive a conditioning input, and the system can process the conditioning input using a visual token generation neural network to generate a sequence of visual tokens that represent a visual output.

As used in this specification, a conditioning input can be a prompt for generating a particular image or a video. The conditioning input can include, e.g., text, audio, or images. When the conditioning input includes one or more images, the system can generate visual tokens representing the one or more images as described above and use the visual tokens as the conditioning input.

In this example, once generated, the system can process the sequence of visual tokens using a decoder neural network to generate the visual output. As used in this specification, the visual output can be an image or a video.

In some implementations, the system can process a decoder input that includes the respective visual tokens identified in the quantized representation of the visual input using a decoder neural network to generate a reconstruction of the visual input.

In some implementations, the system can train the decoder neural network and the encoder neural network on a loss function that measures a reconstruction quality of the reconstruction. In some implementations, the loss function includes an entropy term that measures an entropy of the quantized representation.

In some implementations, the integer values are binary values, and the set of integer values includes only two values.

In some implementations, mapping each dimension of the feature vector to the corresponding integer values includes mapping each dimension independently to a corresponding binary value by applying a sign function to the value of the feature vector in the dimension.

In some implementations, generating data identifying the visual token includes determining a visual token index of the visual token based at least in part on a sum of, for each dimension of the visual token that is equal to one, an exponential of an index of the dimension.

In some implementations, the visual input is a video that includes multiple images, and each feature vector corresponds to an image patch of each of the multiple images or a spatio-temporal patch from two or more of the multiple images.

In some implementations, the encoder neural network includes a causal convolutional neural network.

In some implementations, the visual output is an image or a video that comprises multiple images.

In some implementations, each visual token corresponds to a respective image patch of each image of the visual output or a spatio-temporal patch from two or more images of the multiple of a video.

In some implementations, processing the conditioning input using the visual token generation neural network to generate the sequence of visual tokens includes, at each of multiple generation iteration time steps, generating one or more visual tokens of the sequence of visual tokens based at least in part on, for each of the one or more visual tokens, determining a respective distribution over a set of visual token indices conditioned on the conditioning input, where each visual token index corresponds to a visual token in the vocabulary of visual tokens, selecting a visual token index using the respective distribution; and selecting, as the visual token, the visual token corresponding to the selected visual token index.

In some implementations, processing the conditioning input using the visual token generation neural network to generate the sequence of visual tokens includes, at each of multiple generation iteration time steps, generating one or more visual tokens of the sequence of visual tokens based at least in part on, for each of the one or more visual tokens, determining a respective distribution over a first set of visual token indices and a second set of visual token indices, where each visual token index of the first set of token indices corresponds to a first visual token in a first vocabulary of visual tokens, and where each visual token index of the second set of token indices corresponds to a second visual token in a second vocabulary of visual tokens, selecting a first visual token index and a second visual token index using the respective distributions, selecting a first visual token corresponding to the selected first visual token index and a second visual token corresponding to the selected second visual token index, and concatenating the first visual token and the second visual token to generate the visual token.

In some implementations, the visual token generation neural network is an autoregressive language model neural network. In this case, the autoregressive language model neural network generates a respective visual token at each of the multiple generation iteration time steps by processing the visual tokens in the sequence as of the generation iteration time step conditioned on the conditioning input to select a visual token, and appending the selected visual token to the end of the sequence.

In some implementations, the visual token generation neural network is a masked language model neural network. In this case, the masked language model neural network generates the one or more visual tokens at each of the multiple generation iteration time steps by processing at least the one or more already-generated visual tokens and the conditioning input to generate a respective distribution for each masked visual token of the multiple masked visual tokens. selecting one or more of the masked visual tokens of the plurality of visual masked tokens, and replacing each selected masked visual token with a visual token selected by using the respective distribution for the selected masked visual token.

Particular embodiments of the subject matter described in this specification can be implemented so as to realize one or more of the following advantages.

Visual token generation can be used to perform a variety of downstream tasks, e.g., compression, decompression, and visual output generation of images or videos.

Some conventional systems use diffusion neural networks to generate visual outputs by processing continuous visual tokens. However, making use of diffusion neural networks can be computationally expensive compared to other generative neural networks, such as language models. Some other conventional systems have incorporated language models for visual output generation; however, the large language models generally generate visual outputs with less accuracy than diffusion neural networks, as large language models are less effective in processing continuous tokens.

On the other hand, conventional systems typically identify visual tokens from a vocabulary of visual tokens (e.g., a codebook) by searching through several embedding dimensions of the codebook to identify a closest respective visual token for an encoded representation of the visual input. Performing this extensive search of the multiple embedding dimensions results in the system generating visual inputs with increased latency.

In contrast, the described system uses quantization techniques to generate discrete visual tokens that are more compatible with particular neural networks, such as large language models, for more efficient visual output generation. Additionally, the described quantization techniques allow for the system to directly identify the visual tokens using one or more token identifiers.

In particular, the system jointly pre-trains an encoder neural network and a decoder neural network to reconstruct a visual input based on the quantization techniques. In particular, the system can receive a visual input of one or more images, and the system can process the visual input using the trained encoder neural network to generate multiple feature vectors that represent the visual input, where each feature vector has multiple dimensions. The system then quantizes each feature vector to generate a quantized representation for each of the feature vectors, where the quantized representation includes a token identifier corresponding to a visual token from a vocabulary of visual tokens.

Specifically, the system quantizes the feature vectors by mapping each dimension of the feature vector to a corresponding integer value, and the system identifies the visual token corresponding to the feature vector by combining the integer values to generate a token identifier. For example, the system can map each dimension of the feature vector independently to a binary value by applying a sign function, and the system can determine the token identifier by combining the binary values. In particular, the system combines the binary values based on a sum of an exponential for each dimension, where the system disregards particular integer values from the sum. The system can then directly identify a corresponding visual token using the unique token identifier for multiple token identifiers without “looking up” the visual tokens within the vocabulary, and the system can process a sequence of identified visual tokens using the trained decoder neural network to generate a reconstruction of the visual input.

Additionally, the system can leverage the trained decoder to perform visual generation. In particular, the system can receive a conditioning input that includes prompt and a visual input (e.g., a conditioning input) for generating a visual output, and the system can process the conditioning input using a visual token generation neural network to generate visual tokens representing a visual output. The system can pre-train the visual token generation neural network to generate the discrete visual tokens, where each visual token is a vector that includes the respective binary value for each of the multiple dimensions corresponding to a feature vector. In particular, over multiple iterations, the visual token generation neural network can generate one or more visual tokens by determining a distribution over the indices of the visual tokens. For example, the visual token generation neural network can be an auto-regressive neural network or a masked language model, and the system can leverage the models' ability to generate discrete tokens to generate the visual tokens. In this case, the system can process the visual tokens using the decoder neural network to generate the visual output.

Overall, the described quantization techniques allow for efficiently generating discrete visual tokens, which can result in more accurate compression and decompression of a visual input. Additionally, by implementing the described quantization techniques as a backbone for visual output generation, the system can more effectively use a generative neural network, such as a large language model, and the pre-trained decoder to generate the visual output.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example visual input reconstruction system.

FIG. 2 shows an example visual output generation system.

FIG. 3 shows an example visual input processing system.

FIG. 4 is a flow diagram of an example process for quantizing a visual input.

FIG. 5 is a flow diagram of an example process for generating a visual output by processing a conditioning input.

FIG. 6 is a diagram of the results of visual input reconstruction and visual input generation using quantization techniques.

Like reference numbers and designations in the various drawings indicate like elements.

### DETAILED DESCRIPTION

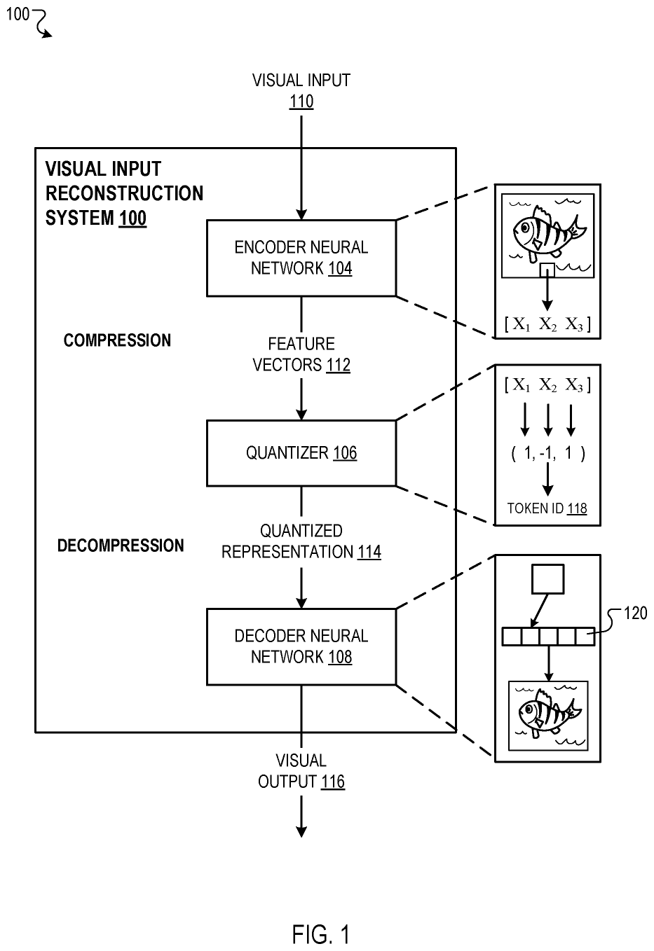

FIG. 1 shows an example visual input reconstruction system 100. The visual input reconstruction system 100 is an example of a system implemented as computer programs on one or more computers in one or more locations, in which the systems, components, and techniques described below can be implemented.

The visual input reconstruction system 100 is configured to perform compression by quantizing a visual input 110 and/or to perform decompression by generating a reconstruction of the visual input 110. The visual input 110 can be an image or a video including multiple images (e.g., video frames) at different time points. The visual input reconstruction system 100 is configured to receive the visual input 110, e.g., from a user device, from another system, or from a memory accessible by the system 100.

Generally, systems can leverage visual token generation to perform compression, decompression, and visual output generation using generative neural networks. That is, systems can map visual tokens to pixels of a visual input and/or process the visual tokens to generate a reconstruction of the visual input. Additionally, systems can generate visual outputs by processing visual tokens using diffusion neural networks. However, incorporating diffusion neural networks can be computationally expensive in comparison to other generative neural networks, such as large language models (LLMs). Some other conventional systems have incorporated language models for visual token generation, but language models are generally trained to process tokens of a discrete latent format (e.g., discrete text tokens), not continuous visual tokens. This incompatibility results in less accurate generation of visual outputs in comparison to diffusion neural networks.

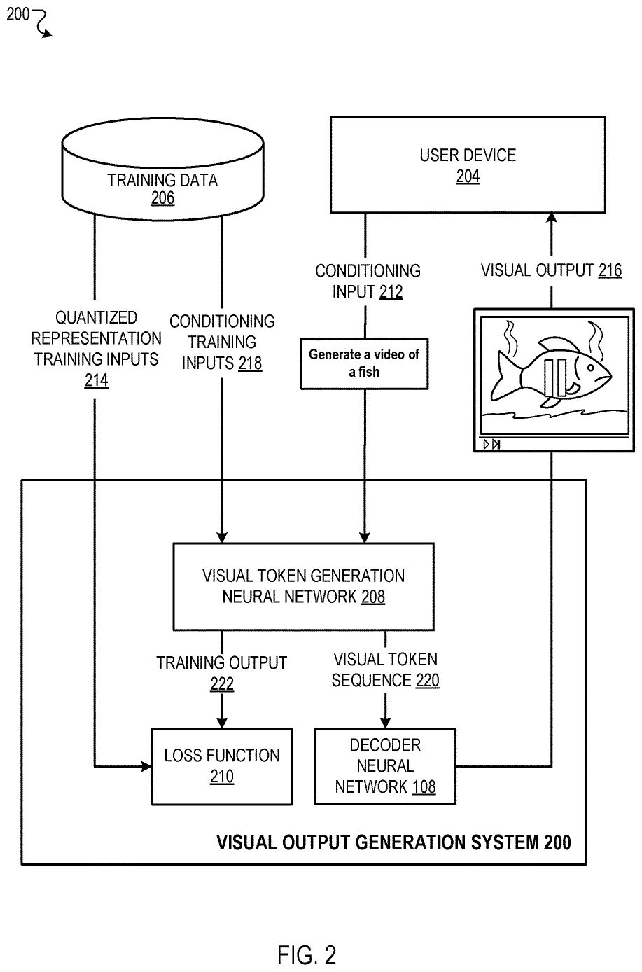

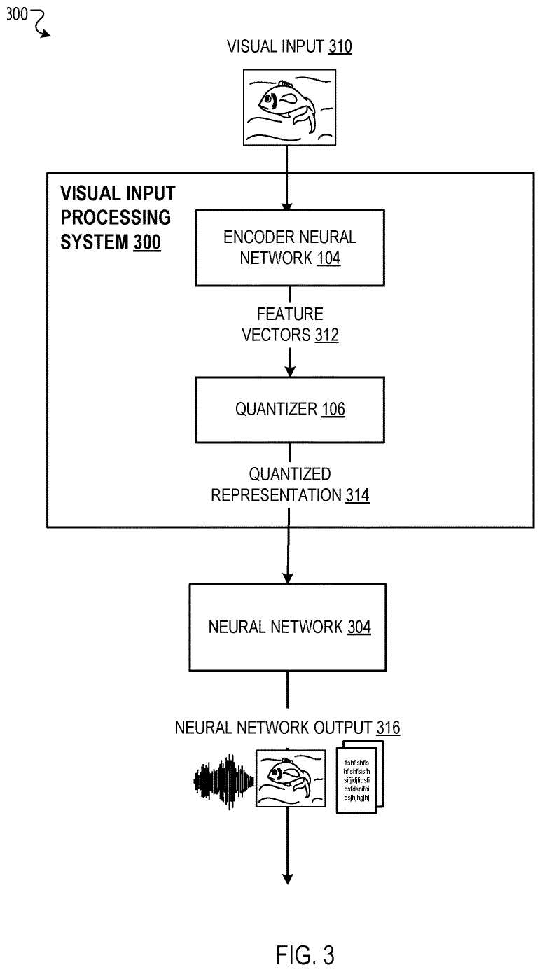

In contrast, the visual input reconstruction system 100 uses quantization techniques to generate discrete visual tokens that represent visual inputs, which allows the system to efficiently leverage large language models for visual output generation, as described in further detail below with reference to FIGS. 2 and 3.

Conventionally, a vocabulary of visual tokens (e.g., a codebook) includes multiple embedding dimensions of visual tokens, such that a system must search through several embedding dimensions to identify a closest respective visual token for a feature vector. In contrast, the visual input reconstruction system 100 directly identifies the visual tokens using the one or more token identifiers determined from the dimensions of the vectors. That is, the system can use the token identifier to select visual tokens without “looking up” visual tokens in multiple dimensions of the vocabulary of visual tokens. By employing these quantization techniques, the system ensures greater efficiency in token generation and greater preservation of visual information.

The visual input reconstruction system 100 includes a pre-trained encoder neural network 104, a quantizer 106, and a pre-trained decoder neural network 108. The system 100 is configured to perform compression by processing the visual input 110 using the encoder neural network 104 and the quantizer 106 to generate the quantized representation 114. Additionally, the system 100 is configured to perform decompression by processing the quantized representation 114 using the decoder neural network 108 to generate the visual output 116 (e.g., the reconstruction of the visual input 110).

The encoder neural network 104 is configured to process the visual input 110 to generate feature vectors 112. The feature vectors 112 are vectors of one or more dimensions that represent the visual input 110. The encoder neural network 104 can be any appropriate neural network that can map the visual input 110 to respective feature vectors 112. For example, the encoder neural network 104 can be a Transformer, a convolutional neural network, a vision Transformer, or a recurrent neural network. In particular, the encoder neural network 104 can be a pre-trained Variational AutoEncoder (VAE) or a pre-trained Convolutional AutoEncoder (CAE). The encoder neural network 104 can be a causal convolutional neural network. A casual convolutional neural network is a convolutional neural network in which predictions at a timestep t cannot depend on data from a future timestep, t. A causal convolutional neural network comprises one or more causal convolutional layers. For example, for a regular 3D convolution layer with kernel size (kₜ, kₕ, k_{w}), the temporal padding scheme includes frames before and frames after the input frames. In contrast, a causal 3D convolution layer pads with kₜ−1 frames before the input and nothing after, so that the output for each frame only depends on the previous frames.

In particular, the encoder neural network 104 can map each visual patch of the visual input 110 to a respective feature vector 112. For example, in the case where the visual input is an image, the encoder neural network 104 can map each image patch of the image to a respective feature vector 112. As shown in FIG. 1, an image patch of the image of the fish can be mapped to a feature vector [X₁ X₂ X₃], where X represents a particular numeric value.

In the case where the visual input is a video, the encoder neural network 104 can map each image patch of each of the video frames to a respective feature vector 112. In another example, the encoder neural network 104 can map each spatio-temporal patch from two or more of the video frames to a respective feature vector 112. For example, the system can map co-located patches within multiple different adjacent video frames to the feature vectors 112 (e.g., feature vector [X₁ X₂ X₃]).

The quantizer 106 is configured to process the feature vectors 112 to generate the quantized representation 114. The quantized representation 114 includes data that identifies respective visual tokens for each feature vector 112. In particular, the quantized representation 114 includes one or more token identifiers 118 that correspond to a visual token of a vocabulary of visual tokens. Advantageously, the token identifiers 118 are discrete representations of the visual tokens, allowing for greater adaptability in both reconstruction and visual generation.

In particular, the system quantizes each feature vector 112 using the quantizer 106 by mapping each dimension of the feature vector 112 to a corresponding integer value from a set of integer values. The system then combines each of the integer values to determine the unique token identifier 118 for the feature vector 112.

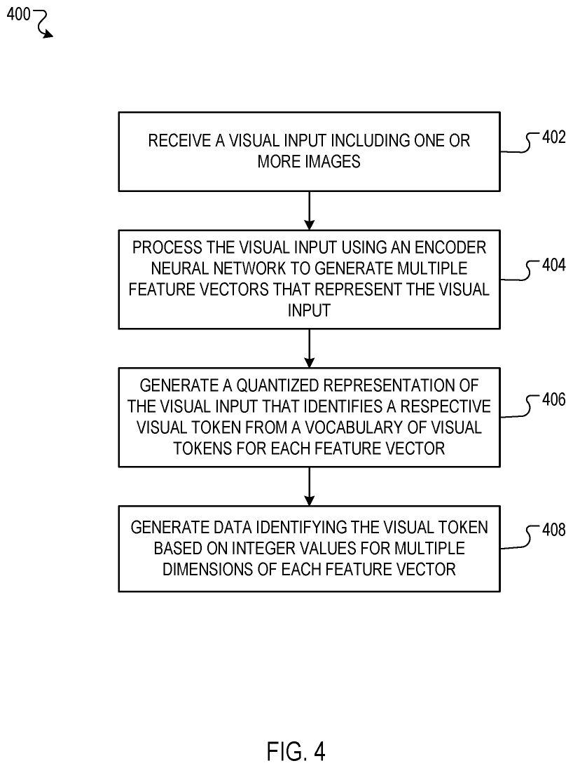

For example, the integer values can be binary values, and the set of integer values can include only two values (e.g., −1 and 1). The system can map each dimension of the feature vector 112 (e.g., feature vector [X₁ X₂ X₃] as shown in FIG. 1) independently to a binary value (−1 or 1), and the system can determine the token identifier 118 based on combining the binary values, as described in further detail below with reference to FIG. 4. Importantly, by combining the binary values based on a sum of an exponential, the system can determine unique token identifiers 118, resulting in the system refraining from having to look up the tokens from a codebook.

The system 100 can then map each token identifier 118 to a particular visual token to generate the visual token sequence 120 representing a compressed version of the reconstruction of the visual input (e.g., the image of the fish). In some examples, the token identifier 118 is the corresponding index of the visual token within the vocabulary of visual tokens.

In some examples, the system can retrieve the token identifiers 118 in order to provide the corresponding visual tokens to the decoder neural network 108 to perform decompression (e.g., reconstruction) of a visual input. For example, the token identifiers 118 may be retrieved from storage, transmitted over a communications network (e.g., the Internet), and/or encoded as a bitstream (e.g., through entropy encoding), where each of the token identifiers 118 are mapped to a bit value. In this case, the system can store or transmit the bitstream over a communications network and then subsequently retrieve the bitstream to perform decompression.

The decoder neural network 108 is configured to process the visual token sequence 120 to generate the visual output 116. For example, the decoder neural network 108 can decode the visual token sequence 120 to generate the reconstruction of the image of the fish.

The decoder neural network 108 can be any appropriate neural network that can decode the visual tokens to generate the visual output 116. For example, the decoder neural network 108 can be a Transformer, a convolutional neural network, a vision Transformer, or a recurrent neural network. In particular, the decoder neural network 108 can have an architecture that is symmetrical to the encoder neural network 104 (e.g., a pretrained Variational AutoEncoder (VAE) or a pre-trained Convolutional AutoEncoder (CAE)). During training, the system 100 can jointly train the encoder neural network 104 and the decoder neural network on a loss function that measures a reconstruction quality of the reconstruction.

For example, the system 100 can train the encoder neural network 104 and the decoder neural network 108 on a dataset of multiple videos, images or both, where the system 100 evaluates the reconstruction on the loss function using the visual output 116, and, optionally, an entropy loss using the quantized representation 114. The reconstruction loss function can be represented by Equation 1:

$$Loss = \frac{1}{n} \sum {( g ( x ) - v ( x ) )}^{2} - {L}_{entropy} \qquad ( 1 )$$

where n represents the number of dataset examples, g(x) represents a ground truth representation, and v(x) represents the visual output 116.

The loss function can include an entropy term that measures an entropy of the quantized representation 114, as shown in Equation 2:

$${L}_{entropy} = E [ H ( q ( x ) ) ] - H [ E ( q ( x ) ) ] \qquad ( 2 )$$

Where E is the expectation operator, q(x) represents the quantized representation 114.

In particular, given the independence of the dimensions of the quantized representation, H(q(x)) can be represented by Equation 3:

$$H ( q ( x ) ) = {\sum }_{i = 1}^{{log}_{2} K} H ( q ( {x}_{i} ) ) \qquad ( 3 )$$

That is, the H[E(q(x))] term can be approximated with sub-groups of dimensions. For example, the H[E(q(x))] term can be approximated for sub-groups of dimensions for K>2¹⁸, where direct estimation is memory bound.

Additionally, the system 100 can train the encoder neural network 104 and the decoder neural network 108 using a GAN loss function (e.g., a min-max loss), a perceptual loss, a commitment loss, or a combination thereof.

After training, the system can use the decoder neural network 108 to perform visual output generation, as described in FIG. 2, and/or use the encoder neural network 104 to perform visual input processing, as described in FIG. 3.

FIG. 2 shows an example visual output generation system 200. The visual output generation system 200 is an example of a system implemented as computer programs on one or more computers in one or more locations, in which the systems, components, and techniques described below can be implemented.

The visual output generation system 200 is configured to process a conditioning input 212 to generate a visual output 216. As used in this specification, a conditioning input can be a prompt for generating a particular image or a video. The conditioning input can include, e.g., text, audio, or images.

The conditioning input 212 can include text, an image, a video, or a combination thereof. For example, the conditioning input 212 can include a text prompt (e.g., “Generate a video of a fish”). In another example, the conditioning input 212 can include a text prompt (e.g., “Generate a video of the fish in this image”) and an image (e.g., an image of a fish). In another example, the conditioning input 212 can include a text prompt (e.g., “Generate a video of this fish flying”) and a video (e.g., a video of a fish swimming). In some examples, the visual output generation system 200 can receive the conditioning input 212 from a user device 204, and the system 200 can provide the visual output 216 to the user device 204.

The visual output generation system 200 includes a visual token generation neural network 208 and a pre-trained decoder neural network (e.g., the pre-trained decoder neural network 108 of FIG. 1). The system 200 processes the conditioning input 212 using the visual token generation neural network 208 to generate a visual token sequence 220, and the system 200 processes the visual token sequence 220 using the decoder neural network 108 to generate the visual output 216.

In particular, the visual token generation neural network 208 is configured to process a variety of inputs, such as images, videos, and text to generate the visual token sequence 220.

For example, when the conditioning input 212 includes one or more images, the system can generate quantized representations representing the one or more images using the encoder neural network 104 and the quantizer 106 as described above. The system can then use the quantized representations as the conditioning input 212 for generating the visual token sequence 220. Each visual token of the visual token sequence 220 is a vector that includes respective integer values from a set of integer values for each of multiple dimensions, as described in FIG. 1.

The visual token generation neural network 208 can be any appropriate type of generative model that can be used to generate an output specifying a sequence of visual tokens from any given conditioning input.

For example, the neural network 208 can be a language model neural network that generates visual token sequences 220 from a visual token vocabulary corresponding to a visual token vocabulary that includes identifiers for visual tokens, e.g., conditioned on the conditioning input 212. To generate a particular token at a particular position within an output sequence, the neural network 208 can determine a score distribution, e.g., a probability distribution, that assigns a respective score, e.g., a respective probability, to each token over a set of visual token indices conditioned on the conditioning input 212 and, in some cases, the visual tokens already generated at preceding positions in the sequence. The neural network 208 can then select, as the particular token, a token from the vocabulary using the score distribution.

In the case where a codebook is relatively large, the system can generate the visual token sequence 220 from two vocabularies corresponding to two concatenated codebooks. Each codebook includes a set of token indices corresponding to visual tokens. In particular, at each generation time step, the neural network 208 can determine a respective score distribution over a first set of token indices and a second set of token indices. The neural network 208 can then select a first visual token and a second visual token using the score distribution, and the neural network 208 can concatenate the first visual token and the second visual token to generate the particular token.

In some examples, the neural network 208 can be an auto-regressive Transformer-based neural network (e.g., ImageGPT, DALL-E, Parti, etc.) that predicts the next token in a sequence given the previous tokens, along with additional conditioning.

In particular, the neural network 208 can include multiple attention blocks that each apply a self-attention operation and an output subnetwork that processes an output of the last attention block to generate the visual token sequence 220. In this case, the neural network 208 auto-regressively generates the output sequence of tokens by generating each particular token in the output sequence conditioned on a current input sequence as of the generation iteration time step that includes any tokens that precede the particular visual token in the output sequence (e.g., the tokens that have for already been generated for any previous positions in the output sequence at previous generation iteration time steps that precede the particular position of the particular token and the conditioning input 212).

In particular, at each generation time step, the neural network 208 processes the visual tokens conditioned on the conditioning input to select a visual token, and the neural network 208 appends the selected visual token to the end of the visual token sequence 220.

For example, the current input sequence as of the generation iteration time step when generating a visual token at any given position in the visual token sequence 220 can include the conditioning input 212 and the visual tokens at any preceding positions that precede the given position in the visual token sequence 220. As a particular example, the current input sequence can include the conditioning input 212 followed by the visual tokens at any preceding positions that precede the given position in the visual token sequence 220. Optionally, the conditioning input 212 and the current output sequence can be separated by one or more predetermined tokens within the current input sequence.

In some other examples, the neural network 208 can be a masked language neural network (MaskGIT, MAGVIT, Phenaki, MUSE, etc.) that is pre-trained on a masked token objective where one or more tokens in the sequence are randomly masked, and the neural network 208 selects visual tokens for the masked tokens by applying a cross-attention operation conditioned on the conditioning input 212.

In particular, the sequence of visual tokens can include multiple masked visual tokens and multiple already-generated tokens. At each generation iteration time step, the neural network 208 processes the already-generated tokens and the conditioning input 212 to generate a respective score distribution for each masked token. The neural network 208 then selects one or more of the masked visual tokens based on the score distribution. For example, the neural network 208 can select the masked visual token with the lowest probability of the distribution. The neural network 208 can then replace each selected masked visual token with a visual token based on the respective distribution for the selected masked visual token.

The decoder neural network 108 is configured to process the visual token sequence 120 and generate the visual output 216, as described above. In particular, each visual token of the visual token sequence 120 can correspond to a respective image patch of each image of the visual output 216 or a spatio-temporal patch from two or more video frames of a video. The decoder neural network 108 can decode the visual token sequence 120 to output the particular images or video.

During training, the system 200 trains the visual token generation neural network 208 on training data 206 by evaluating the outputs of the visual token generation neural network 208 with a loss function 210. In particular, the training data 206 includes multiple quantized representations (e.g., quantized representation 114) corresponding to conditioning inputs. In particular, each conditioning training input 218 can include text, images, or video. In the case where the conditioning inputs include images, video, or both, the system 200 can process the images, video, or both using the encoder neural network 104 and the quantizer 106 to generate a quantized representation of the conditioning inputs.

In particular, to train the visual token generation neural network 208, the system 200 processes conditioning training inputs 218 using the visual token generation neural network 208 to generate a training output 222. The conditioning training inputs 218 include a subset of the conditioning inputs of the training data 206. The training output 222 is an output sequence of visual tokens. In particular, the visual token generation neural network 208 processes the conditioning training inputs 218 to generate respective quantized representations of the conditioning training inputs 218. The system then maps the generated quantized representations and the quantized representation training inputs 214 to one or more visual tokens, respectively, using the vocabulary of visual tokens.

The system 200 then evaluates the training output 222 with a loss function 210 that measures a loss between each visual token of the training output 222 and each visual token of the corresponding quantized representation training inputs 214. In particular, the loss function 210 can be any loss function that includes a term that represents an error between a particular visual token of the training output 222 and a corresponding ground-truth visual token (e.g., the corresponding visual token of the quantized representation training input 214).

FIG. 3 shows an example visual input processing system. The visual input processing system 300 is an example of a system implemented as computer programs on one or more computers in one or more locations, in which the systems, components, and techniques described below can be implemented.

The visual input processing system 300 is configured to process a visual input 310 to generate a quantized representation 314 (e.g., the quantized representation 114 of FIG. 1). The system can then provide the quantized representation 314 to a neural network 304, and the neural network 304 can process the quantized representation 314 to generate a neural network output 316.

As described in FIG. 1, the system 300 can process the visual input 310, such as an image or video, using a pre-trained encoder neural network 104 to generate the feature vectors 312. The system 300 can then process the feature vectors 312 using the quantizer 106 to generate the quantized representation 314. The quantized representation 314 can include multiple token identifiers corresponding to one or more visual tokens, and the system 300 can map each token identifier to the one or more visual tokens using the vocabulary of visual tokens, as described in further detail below with reference to FIG. 4.

In some examples, the system 300 can merely provide the token identifiers to the encoder neural network 104. In this case, the system 300 can map the token identifiers to an embedding, and the system 300 can process the embedding using the encoder neural network 104.

The system can then provide the sequence of visual tokens to the neural network 304 to generate the neural network output 316. The neural network output 316 can be text, audio, an image, or video. For example, the neural network 304 can be a multi-modal neural network configured to generate audio or text by processing a sequence of visual tokens. In another example, the neural network 304 can be a classifier neural network configured to generate a text label of the visual input by processing the sequence of visual tokens. In another example, the neural network 304 can be an auto-regressive neural network configured to generate a next video frame of the visual input by processing the sequence of visual tokens.

The neural network 304 can be a multi-layer perceptron (MLP), or a Transformer neural network, e.g., a Vision Transformer.

For example, the neural network 304 can have any of a variety of Transformer-based neural network architectures. Generally, however, the Transformer-based neural network includes a sequence of attention blocks (a block that applies an attention mechanism over a block input to generate a block output), and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

FIG. 4 is a flow diagram of an example process for quantizing a visual input. For convenience, the process 400 will be described as being performed by a system of one or more computers located in one or more locations. For example, a visual input reconstruction system or a visual input processing system, e.g., the visual input reconstruction system 100 of FIG. 1 or the visual input processing system 300 of FIG. 3, appropriately programmed, can perform the process 400.

The system can receive a visual input including one or more images (402). For example, the visual input can be a video that includes multiple images representing multiple adjacent video frames.

The system can process the visual input using an encoder neural network to generate multiple feature vectors that represent the visual input (404).

The system can generate a quantized representation of the visual input that identifies a respective visual token from a vocabulary of visual tokens for each feature vector (406).=

In particular, the system maps each dimension of the feature vector to a corresponding integer value from a set of integer values. For example, the system can map each dimension xᵢ of the feature vector independently to a corresponding binary value (e.g., −1 and 1) by applying a sign function to a particular dimension, as shown in Equation 4 below:

$$q ( {x}_{i} ) = sign ( {x}_{i} ) = - 1 \{ {x}_{i} \leq 0 \} + 1 \{ {x}_{i} > 0 \} \qquad ( 4 )$$

where xᵢ represents the value of the i-th dimension of the feature vector, and the system maps each dimension i to −1 or 1 based on the corresponding vector value of the particular dimension. For example, as shown in FIG. 1, the system can map the feature vector of three dimensions to [1, −1, 1] based on the values of the dimensions.

The system can generate data identifying the visual token based on the integer values for the multiple dimensions of each feature vector (408). In particular, the system can determine a visual token index (e.g., a visual token identifier) of each visual token based on a sum of an exponential for each dimension, as shown in Equation 5 below:

$$Id ( x ) = {\sum }_{i = 1}^{{log}_{2} K} {2}^{i - 1} * 1 \{ {x}_{i} > 0 \} \qquad ( 5 )$$

Where log₂ K is the total number of dimensions of the feature vector, and K is the total number of visual tokens in the vocabulary and, equivalently, the total number of integer values required to represent the visual tokens. In particular, the system computes the visual token identifier by determining the sum of an exponential of the index of the dimension for each of the integer values (e.g., integer values corresponding to the dimension) that are equal to 1. That is, the system can disregard the integer values that are equal to −1 from the sum.

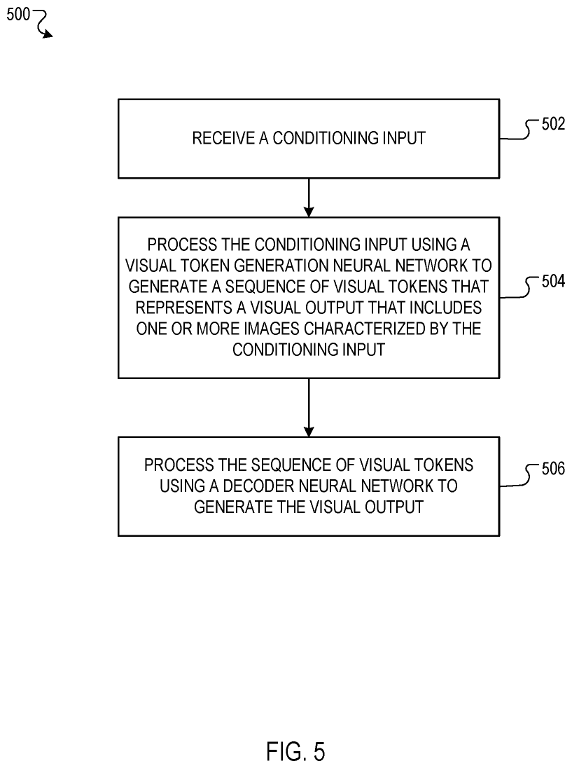

FIG. 5 is a flow diagram of an example process for generating a visual output by processing a conditioning input. For convenience, the process 500 will be described as being performed by a system of one or more computers located in one or more locations. For example, a visual output generation system, e.g., the visual output generation system 200 of FIG. 2, appropriately programmed, can perform the process 500.

The system can receive a conditioning input (502). For example, the conditioning input can include text, such as a prompt for the system to generate a particular image or video. In some examples, the conditioning input can include text and a visual input, such as an image or a video.

The system can process the conditioning input using a visual token generation neural network to generate a sequence of visual tokens that represents a visual output that includes one or more images characterized by the conditioning input (504). Each visual token is selected from a vocabulary of visual tokens, and each visual token in the vocabulary is a vector that includes a respective integer value from a set of integer values for each of multiple dimensions. For example, the integer values can be binary values (e.g., −1 and 1) mapped from feature vectors as described above in FIGS. 1 and 4.

In particular, the system can process the conditioning input to generate the sequence of visual tokens at multiple generation time steps. At each generation time step, the system generates one or more visual tokens of the sequence of visual tokens based on determining a respective distribution over a set of visual token indices conditioned on the conditioning input for each of the one or more visual tokens. Each visual token index corresponds to a visual token in a vocabulary of visual tokens. The system then selects a token index using the respective distribution, and the system selects the visual token corresponding to the selected visual token index as the visual token.

In some examples, the system determines a respective distribution over a first set of token indices and a second set of visual token indices. That is, the system can divide the visual token indices into two sets each corresponding to a different vocabulary of visual tokens, and the system can determine a distribution over each set. In particular, each visual token index of the first set can correspond to a first visual token in a first vocabulary of visual tokens, and each visual token index of the second set can correspond to a second visual token in a second vocabulary of visual tokens.

In this case, the system selects the first visual token index and the second visual token index using the respective distributions, and the system can select the visual tokens corresponding to the selected token indices, respectively. In particular, the system selects the first visual token corresponding to the selected first visual token index, and the system selects the second visual token corresponding to the selected second visual token index. The system then concatenates the first visual token and the second visual token to generate the visual token.

In some examples, the visual token generation neural network can be an autoregressive language model neural network that generates the respective visual tokens by appending a selected visual token to the end of the sequence of visual tokens. In particular, at each generation iteration time step, the autoregressive language model neural network processes the visual tokens in the sequence as of the generation time step conditioned on the conditioning input to select a visual token, and the system appends the selected visual token to the end of the sequence.

In some other examples, the visual token generation neural network is a masked language model neural network, and the sequence of visual tokens includes multiple masked visual tokens and one or more already-generated visual tokens. The masked language model neural network generates the respective visual tokens by replacing the masked visual tokens with selected visual tokens using the respective distribution of the masked visual token. In particular, at each generation iteration time step, the masked language model neural network processes the one or more already-generated visual tokens and the conditioning input to generate a respective distribution for each masked visual token. The masked language model neural network then selects one or more of the masked visual tokens of the multiple visual masked tokens, and the system replaces each selected masked visual token with a visual token selected using the respective distribution for the selected masked visual token.

The system can process the sequence of visual tokens using a decoder neural network to generate visual output (506). The visual output can be an image or a video, and each visual token can correspond to a respective image patch of each image of the visual output or a spatio-temporal patch from two or more images of the images (e.g., video frames) of the video.

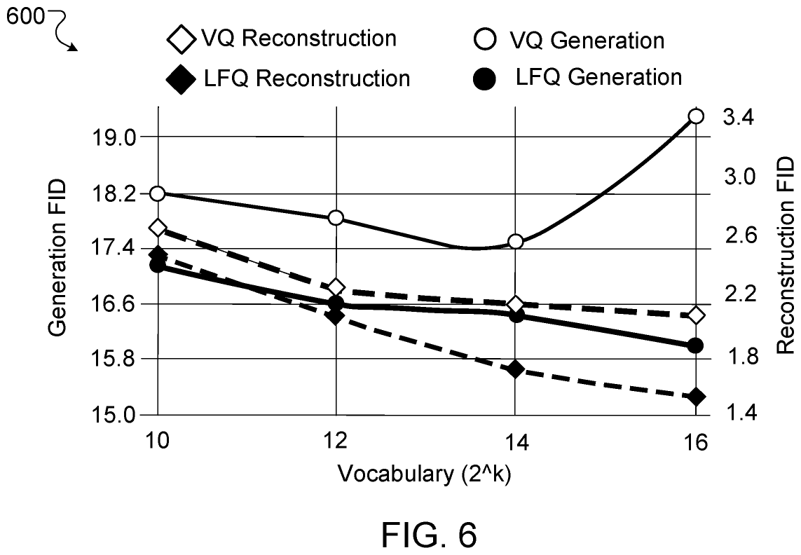

FIG. 6 is a diagram of results of visual input reconstruction and visual input generation using quantization techniques as described in this specification.

The graph of FIG. 6 illustrates the performance of visual reconstruction and visual generation computed using a Fréchet Inception Distance (FID) metric that measures the quality of reconstructed and generated images, where a lower FID metric value represents a relatively higher quality of the reconstructed or generated images.

In particular, the graph shows the performance of a pre-existing vector quantization procedure (VQ) that includes codebook look-up, and the described procedure of look-up free quantization (LFQ). As shown, the look-up free quantization technique results in both improved generation and reconstruction of images based on the FID metric. In particular, as the size of the vocabulary increases, the look-up free quantization technique has relatively higher generation quality and relatively higher reconstruction quality.

Thus, by implementing the described quantization techniques, the system can more accurately reconstruct a visual input, and the system can more effectively use a generative neural network to generate the visual output.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for quantizing a visual input, comprising:
receiving a visual input comprising one or more images;
processing the visual input using an encoder neural network to generate a plurality of feature vectors that represent the visual input;
generating a quantized representation of the visual input that identifies a respective visual token from a vocabulary of visual tokens for each feature vector, the generating comprising:
for each feature vector of the plurality of feature vectors, quantizing the feature vector to generate a quantized representation that maps each dimension of a plurality of dimensions of the feature vector to a corresponding integer value from a set of integer values; and
generating data identifying the visual token based on the integer values for the plurality of dimensions.

2. The computer-implemented method of claim 1, further comprising:
processing a decoder input that comprises the respective visual tokens identified in the quantized representation of the visual input using a decoder neural network to generate a reconstruction of the visual input.

3. The computer-implemented method of claim 2, further comprising:
training the decoder neural network and the encoder neural network on a loss function that measures a reconstruction quality of the reconstruction.

4. The computer-implemented method of claim 3, wherein the loss function includes an entropy term that measures an entropy of the quantized representation.

5. The computer-implemented method of claim 1, wherein the integer values are binary values, and wherein the set of integer values includes only two values.

6. The computer-implemented method of claim 5, wherein mapping each dimension of the feature vector to the corresponding integer values further comprises:
mapping each dimension independently to a corresponding binary value by applying a sign function to the value of the feature vector in the dimension.

7. The computer-implemented method of claim 6, wherein generating data identifying the visual token comprises:
determining a visual token index of the visual token based at least in part on a sum of, for each dimension of the visual token that is equal to one, an exponential of an index of the dimension.

8. The computer-implemented method of claim 1, wherein the visual input is a video that comprises a plurality of images, and wherein each feature vector corresponds to an image patch of each of the plurality of images or a spatio-temporal patch from two or more of the plurality of images.

9. The computer-implemented method of claim 1, wherein the encoder neural network comprises a causal convolutional neural network.

10. A computer-implemented method, comprising:
receiving a conditioning input;
processing the conditioning input using a visual token generation neural network to generate a sequence of visual tokens that represents a visual output that comprises one or more images characterized by the conditioning input, wherein each visual token is selected from a vocabulary of visual tokens, and wherein each visual token in the vocabulary is a vector that comprises a respective integer value from a set of integer values for each of a plurality of dimensions; and
processing the sequence of visual tokens using a decoder neural network to generate the visual output.

11. The computer-implemented method of claim 10, wherein the visual output is an image or a video that comprises a plurality of images.

12. The computer-implemented method of claim 11, wherein each visual token corresponds to a respective image patch of each image of the visual output or a spatio-temporal patch from two or more images of the plurality of images of a video.

13. The computer-implemented method of claim 10, wherein the integer values are binary values.

14. The computer-implemented method of claim 10, wherein processing the conditioning input using the visual token generation neural network to generate the sequence of visual tokens further comprises:
at each of a plurality of generation iteration time steps:
generating one or more visual tokens of the sequence of visual tokens based at least in part on, for each of the one or more visual tokens:
determining a respective distribution over a set of visual token indices conditioned on the conditioning input, wherein each visual token index corresponds to a visual token in the vocabulary of visual tokens,
selecting a visual token index using the respective distribution; and
selecting, as the visual token, the visual token corresponding to the selected visual token index.

15. The computer-implemented method of claim 10, wherein processing the conditioning input using the visual token generation neural network to generate the sequence of visual tokens further comprises:
at each of a plurality of generation iteration time steps:
generating one or more visual tokens of the sequence of visual tokens based at least in part on, for each of the one or more visual tokens:
determining a respective distribution over a first set of visual token indices and a second set of visual token indices, wherein each visual token index of the first set of token indices corresponds to a first visual token in a first vocabulary of visual tokens, and wherein each visual token index of the second set of token indices corresponds to a second visual token in a second vocabulary of visual tokens;
selecting a first visual token index and a second visual token index using the respective distributions;
selecting a first visual token corresponding to the selected first visual token index and a second visual token corresponding to the selected second visual token index; and
concatenating the first visual token and the second visual token to generate the visual token.

16. The computer-implemented method of claim 10, wherein the visual token generation neural network is an autoregressive language model neural network.

17. The computer-implemented method of claim 16, wherein the autoregressive language model neural network generates a respective visual token at each of the plurality of generation iteration time steps by:
processing the visual tokens in the sequence as of the generation iteration time step conditioned on the conditioning input to select a visual token; and
appending the selected visual token to the end of the sequence.

18. The computer-implemented method of claim 10, wherein the visual token generation neural network is a masked language model neural network.

19. The computer-implemented method of claim 18, wherein the sequence of visual tokens comprises a plurality of masked visual tokens and one or more already-generated visual tokens.

20. The computer-implemented method of claim 19, wherein the masked language model neural network generates the one or more visual tokens at each of the plurality of generation iteration time steps by:
processing at least the one or more already-generated visual tokens and the conditioning input to generate a respective distribution for each masked visual token of the plurality of masked visual tokens;
selecting one or more of the masked visual tokens of the plurality of visual masked tokens; and
replacing each selected masked visual token with a visual token selected by using the respective distribution for the selected masked visual token.

21. A system comprising:
one or more computers; and
one or more storage devices communicatively coupled to the one or more computers, wherein the one or more storage devices store instructions that, when executed by the one or more computers, cause the one or more computers to perform operations comprising:
receiving a visual input comprising one or more images;
processing the visual input using an encoder neural network to generate a plurality of feature vectors that represent the visual input;
generating a quantized representation of the visual input that identifies a respective visual token from a vocabulary of visual tokens for each feature vector, the generating comprising:
for each feature vector of the plurality of feature vectors, quantizing the feature vector to generate a quantized representation that maps each dimension of a plurality of dimensions of the feature vector to a corresponding integer value from a set of integer values; and
generating data identifying the visual token based on the integer values for the plurality of dimensions.
